(19) United States
(12) Patent Application Publication
(10) Pub. No.: US 2025/0317460 A1
(43) Pub. Date: Oct. 9, 2025

(54) METHODS FOR DETECTING CYBER-ATTACKS AND INCIDENTS, AND SYSTEMS, APPARATUSES, AND NON-TRANSITORY COMPUTER-READABLE STORAGE MEDIA EMPLOYING SAME

(71) Applicant: Royal Bank of Canada, Toronto (CA)

(72) Inventors: Nariman MAMMADLI, Toronto (CA); Sajeed BAKHT, Toronto (CA); Yasaman ENSAFI, Toronto (CA)

(21) Appl. No.: 19/173,578

(22) Filed: Apr. 8, 2025

Related U.S. Application Data
(60) Provisional application No. 63/631,652, filed on Apr. 9, 2024.

(51) Int. Cl. H04L 9/40

(52) U.S. Cl. CPC H04L 63/1425; H04L 63/1441

(57) ABSTRACT

Methods, systems, apparatuses, and non-transitory computer-readable storage media for detecting cyber-attacks and incidents are disclosed. A method for detecting network incidents comprises: receiving outputs from a plurality of artificial intelligence (AI) models analyzing a plurality of network operation streams, wherein the plurality of AI models are respectively trained to detect suspicious events corresponding to a potential type of network incident in a respective network operation stream and to output an alert when a suspicious event is detected; determining, from the outputs of the plurality of AI models, a plurality of suspicious events that are associated with an entity; calculating a probability that two or more of the plurality of suspicious events associated with the entity occurred randomly; and outputting an alert based on the probability.

### CROSS-REFERENCE TO RELATED APPLICATIONS

This application claims priority to U.S. Provisional Patent Application No. 63/631,652, filed on Apr. 9, 2024, the entire contents of which is incorporated by reference herein for all purposes.

### FIELD OF THE DISCLOSURE

The present disclosure relates generally to methods, systems, apparatuses, and non-transitory computer-readable storage media for detecting cyber-attacks and incidents, and in particular to methods, systems, apparatuses, and non-transitory computer-readable storage media for detecting cyber-attacks and incidents using artificial intelligence.

### BACKGROUND

Cyber security is an important consideration for network systems such as the Internet, wide area networks (WANs), metropolitan area networks (MANs), local area networks (LANs) such as network systems of various organizations, and/or the like. One task of cyber security is to detect cyber-attacks and incidents, such as unauthorized data access.

A goal of machine learning (ML) applied to cyber security is to analyze large datasets and detect threats, whether it is an external or insider threat. The datasets analyzed typically cover events across diverse modalities such as browsing, printing, emailing etc. A single ML model that analyzes all these modalities is not possible, hence a divide and conquer method is often pursued. That is, a cyber security solution is built for each modality, and at times multiple solutions for a single modality. For example, given all the Internet traffic events, detecting potential data theft via upload is fundamentally different from detecting malware activity. As a result of above approach, there are often multiple models each analyzing a specific scenario within a specific behaviour modality.

Typically, each model outputs alerts that are consumed by separate teams and stakeholders for that modality. For example, the team responsible for print is different from the team responsible to respond to presence of malware. A problem with this approach is that using multiple models to detect cyber-attacks and incidents provides a very limited view of a given cyber-attack or incident, which typically does not unfold within a single modality but spreads to other modalities as well.

Accordingly, additional, alternative, and/or improved methods, systems, apparatuses, and non-transitory computer-readable storage media for detecting cyber-attacks and incidents remain highly desirable.

### SUMMARY

According to one aspect of this disclosure, there is provided a method for detecting network incidents, the method comprising: receiving outputs from a plurality of artificial intelligence (AI) models analyzing a plurality of network operation streams, wherein the plurality of AI models are respectively trained to detect suspicious events corresponding to a potential type of network incident in a respective network operation stream and to output an alert when a suspicious event is detected; determining, from the outputs of the plurality of AI models, a plurality of suspicious events that are associated with an entity; calculating a probability that two or more of the plurality of suspicious events associated with the entity occurred randomly; and outputting an alert based on the probability.

In some embodiments, the method further comprises creating an ordered list of suspicious events for use in calculating the probability by ordering the plurality of suspicious events associated with the entity based on a time of respective suspicious events.

In some embodiments, the method further comprises filtering the ordered list of suspicious events by: accessing a dictionary of suspicious event pairs; and filtering the ordered list of suspicious events to determine pairs of suspicious events that match suspicious event pairs in the dictionary, wherein the probability is calculated based on the suspicious events that match suspicious event pairs in the dictionary.

In some embodiments, the probability is calculated by: partitioning the suspicious events that match suspicious event pairs in the dictionary to respective AI models of the plurality of AI models; determining, for each of the respective AI models, a number of suspicious events associated with the entity; calculating a sum of all suspicious events associated with the entity by adding the number of suspicious events associated with the entity across the respective AI models; determining, for each of the respective AI models, a number of suspicious events associated with all entities; calculating a sum of all suspicious events associated with all entities by adding the number of suspicious events associated with all entities across the respective AI models; and calculating the probability that the suspicious events occurred randomly using the following Equation:

$$\frac{\prod ( \begin{matrix}{M}_{i} \\ {m}_{i}\end{matrix} )}{( \begin{matrix}N \\ n\end{matrix} )}$$

where Mi is the number of suspicious events associated with all entities for a respective AI model i, mi is the number of suspicious events associated with the entity for the respective AI model i, N is the sum of all suspicious events associated with all entities across the respective AI models, and n is the sum of all suspicious events associated with the entity across the respective AI models.

In some embodiments, calculating the probability is based on a time of occurrence between a pair of suspicious events.

In some embodiments, a mean time-delta of known network incidents having two event types corresponding to the pair of suspicious events is calculated by accessing a database storing suspicious events and timing information for known incidents, and wherein the probability is calculated based on the time of occurrence between the two suspicious events and the mean time-delta.

In some embodiments, the probability is calculated using an exponential cumulative distribution function.

In some embodiments, the method further comprises calculating a surprise score based on the probability that the two or more of the plurality of suspicious events occurred randomly, and outputting the alert when the surprise score exceeds a threshold value.

In some embodiments, the alert is output when the probability is lower than a threshold value.

In some embodiments, the plurality of suspicious events associated with the entity is represented as an ordered graph.

In some embodiments, the method further comprises: converting the ordered graph to a textual format; generating a template based on nodes present in the ordered graph; customizing a prompt for inputting to a large language model (LLM) to summarize the ordered graph, wherein the prompt is customized based on the template; and prompting the LLM to generate a summary report of the two or more suspicious events using the textual format of the ordered graph.

According to one aspect of this disclosure, there is provided one or more processor for performing the above-described method in accordance with any one of the above aspects/embodiments.

According to one aspect of this disclosure, there is provided one or more non-transitory computer-readable storage media comprising computer-executable instructions, wherein the instructions, when executed, cause one or more circuits to perform the above-described method in accordance with any one of the above aspects/embodiments.

According to another aspect of this disclosure, there is provided a system, comprising: an artificial intelligence (AI) engine comprising a plurality of AI models respectively trained to determine suspicious events corresponding to a potential type of network incident in a respective network operation stream; one or more processors; and one or more non-transitory computer-readable storage media comprising computer-executable instructions, wherein the computer-executable instructions, when executed, cause one or more circuits to perform the above-described method in accordance with any one of the above aspects/embodiments.

In some embodiments, the system further comprises a database storing a dictionary of suspicious event pairs.

In some embodiments, the system further comprises a database storing suspicious events and timing information of known network incidents.

In some embodiments, the system further comprises an information-processing module for generating a summary report from an ordered graph.

### BRIEF DESCRIPTION OF THE DRAWINGS

For a more complete understanding of the disclosure, reference is made to the following description and accompanying drawings, in which:

FIG. 1 is a schematic diagram of a computer network system for data sharing, according to some embodiments of the present disclosure;

FIG. 2 is a schematic diagram showing a simplified hardware structure of a computing device of the computer network system shown in FIG. 1;

FIG. 3 a schematic diagram showing a simplified software architecture of a computing device of the computer network system shown in FIG. 1;

FIG. 4 is a schematic diagram showing a simplified software structure of the computer network system shown in FIG. 1 for detecting network incidents, according to some embodiments of this disclosure;

FIG. 5 is a schematic diagram showing a simplified software structure of the computer network system shown in FIG. 1 for detecting network incidents, according to some other embodiments of this disclosure;

FIG. 6 is a schematic diagram showing a simplified software structure of the computer network system shown in FIG. 1 for detecting network incidents, according to yet some other embodiments of this disclosure;

FIG. 7 is a schematic diagram showing the graph representation of an event detected by the AI models in the AI engine shown in FIG. 6, according to some embodiments of this disclosure;

FIG. 8 is a schematic diagram showing an example of the graph representation shown in FIG. 7;

FIG. 9 is a schematic diagram showing the graph representation of a combined event combining the events output from the AI models of in the AI engine shown in FIG. 6, according to some embodiments of this disclosure;

FIGS. 10A and 10B are schematic diagrams showing two examples of the graph representation shown in FIG. 9;

FIG. 11 shows an example of the cumulative distribution function of an exponential distribution with different rate parameters;

FIGS. 12A and 12B show two cases found by the AI engine shown in FIG. 6 for determining the value of the rate parameter for an exponential distribution used in detecting network incidents, according to some embodiments of this disclosure;

FIG. 13 is a schematic diagram showing an example of operations that may be detected as a network incident, wherein an employee triggered a client-lookup (an abnormal data access event) at time zero (0), an anomalous outbound email (a screenshot exfiltration event) at time five (5), and an anomalous print (Print event) at time 10;

FIG. 14 is a flowchart showing a method or procedure for calculating the probabilities of a combined event, according to some embodiments of this disclosure;

FIG. 15 is a flowchart showing a method or procedure for calculating the probabilities of a combined event, according to further embodiments of this disclosure;

FIG. 16 is a schematic diagram showing the detail of an exemplary node of a combined event;

FIG. 17 is a schematic diagram showing an information-processing module for processing the incidents output from the AI engine shown in FIG. 4, FIG. 5, or FIG. 6, to generate an incident-detection report, according to some embodiments of this disclosure;

FIG. 18 is a flowchart showing a procedure performed by the information-processing module shown in FIG. 16 for generating the incident-detection report using a large language model (LLM), according to some embodiments of this disclosure;

FIG. 19 is a depiction showing an example of a network incident detected by the AI engine shown in FIG. 6, which is processed by the information-processing module shown in FIG. 16 in accordance with the flowchart shown in FIG. 17 for generated a report and/or summary; and

FIG. 20 shows a method for detecting network incidents in accordance with embodiments of this disclosure.

### DETAILED DESCRIPTION

Embodiments disclosed herein relates to methods, systems, apparatuses, and non-transitory computer-readable storage media for detecting attack and/or incident scenarios that may occur in a computer network system, and subsequently generating diverse alert types with a holistic view on malicious behaviors across the computer network system.

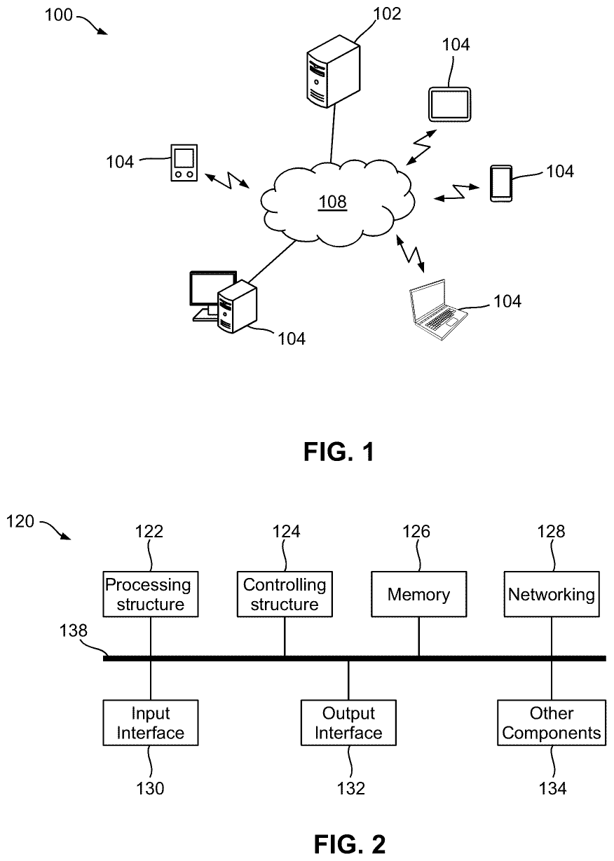

Turning now to FIG. 1, a computer network system is shown and is generally identified using reference numeral 100. As shown, the computer network system 100 comprises one or more server computers 102 and a plurality of computing devices 104 functionally interconnected by a network 108, such as the Internet, a wide area network (WAN), a metropolitan area network (MAN), a local area network (LAN), and/or the like, via suitable wired and/or wireless networking connections.

The server computers 102 may be computing devices designed specifically for use as a server, and/or general-purpose computing devices acting as server computers while also being used by various users. Each server computer 102 may execute one or more server programs.

The computing devices 104 may be portable and/or non-portable computing devices such as laptop computers, tablets, smartphones, Personal Digital Assistants (PDAs), desktop computers, and/or the like. Each computing device 104 may execute one or more application programs. In some embodiments, the computing devices 104 may comprise a server computer of another network system connected to the network system 100.

Generally, the computing devices 102 and 104 have a similar hardware structure such as a hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors and/or controllers using, for example, field-programmable gate array (FPGA) or application-specific integrated circuit (ASIC) technologies, and/or the like.

Generally, each processor of the processing structure 122 comprises necessary circuitries implemented using technologies such as electrical and/or optical hardware components for executing one or more procedures as the implementation purpose and/or the use case maybe, to perform various tasks. In many embodiments, the one or more procedures may be implemented as firmware and/or software stored in the memory 126. Those skilled in the art will appreciate that, in these embodiments, the one or more processors of the processing structure 122, are usually of no use without meaningful firmware and/or software.

Of course, those skilled the art will appreciate that a processor may be implemented using other technologies such as analog technologies.

The controlling structure 124 comprises one or more controlling circuits, such as graphic controllers, input/output chipsets, and the like, for coordinating operations of various hardware components and modules of the computing device 102/104.

The memory 126 comprises one or more one or more non-transitory computer-readable storage devices or media accessible by the processing structure 122 and the controlling structure 124 for reading and/or storing computer-executable instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In use, the memory 126 is generally divided into a plurality of portions for different use purposes. For example, a portion of the memory 126 (denoted as storage memory herein) may be used for long-term data storing, for example, for storing files or databases. Another portion of the memory 126 may be used as the system memory for storing data during processing (denoted as working memory herein).

The network interface 128 comprises one or more network modules for connecting to other computing devices or networks through the network 108 by using suitable wired and/or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, 6G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screens, touch-sensitive whiteboards, touch-pads, keyboards, computer nice, trackballs, microphones, scanners, cameras, and/or the like. The input interface 130 may be a physically integrated part of the computing device 102/104 (for example, the touch-pad of a laptop computer or the touch-sensitive screen of a tablet), or may be a device physically separated from but functionally coupled to, other components of the computing device 102/104 (for example, a computer mouse). The input interface 130, in some implementation, may be integrated with a display output to form a touch-sensitive screen or a touch-sensitive whiteboard.

The output interface 132 comprises one or more output modules for output data to a user. Examples of the output modules include displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or a tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement units (IMUs), and/or the like. Examples of the positioning modules may be one or more global navigation satellite system (GNSS) components (for example, one or more components for operation with the Global Positioning System (GPS) of USA, Global'naya Navigatsionnaya Sputnikovaya Sistema (GLONASS) of Russia, the Galileo positioning system of the European Union, and/or the Beidou system of China).

The system bus 138 interconnects various components 122 to 134 enabling them to transmit and receive data and control signals to and from each other.

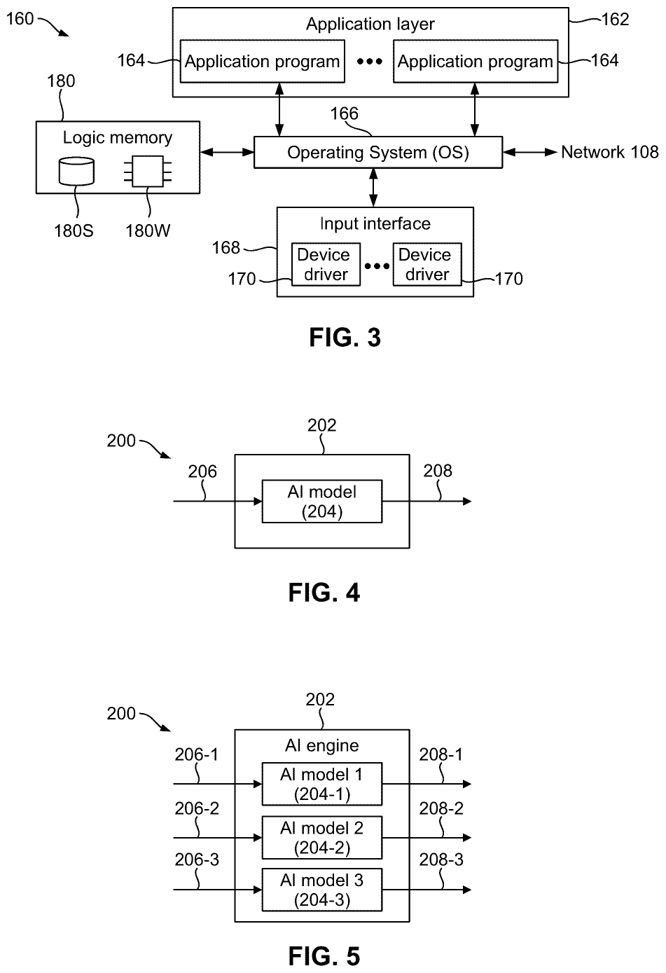

FIG. 3 shows a simplified software architecture of the computing device 102 or 104. The software architecture comprises an application layer 162, an operating system 166, a logical input/output (I/O) interface 168, and a logical memory 180. The application layer 162, operating system 166, and logical I/O interface 168 are generally implemented as computer-executable instructions or code in the form of software programs or firmware programs stored in the logical memory 180 which may be executed by the processing structure 122.

Herein, a software or firmware program is a set of computer-executable instructions or code stored in one or more non-transitory computer-readable storage devices or media such as the memory 126, and may be read and executed by the processing structure 122 and/or other suitable components of the computing device 102/104 for performing one or more procedures. Those skilled in the art will appreciate that a program may be implemented as either software or firmware, depending on the design purposes and requirements. Therefore, for ease of description, the terms “software” and “firmware” may be interchangeably used hereinafter.

Herein, a procedure has a general meaning equivalent to that of a method. More specifically, a procedure herein is a defined method implemented as software or firmware programs executable by hardware components for processing data (such as data received from users, other computing devices, other components of the computing device 102/104, and/or the like). A procedure may comprise or use one or more functions for processing data as designed. Herein, a function is a defined sub-procedure or sub-method for computing, calculating, or otherwise processing input data in a defined manner and generating or otherwise producing output data.

Alternatively, a procedure may be implemented as one or more hardware structures having necessary electrical and/or optical components, circuits, logic gates, integrated circuit (IC) chips, and/or the like.

Referring back to FIG. 3, the application layer 162 comprises one or more application programs 164 executed by or performed by the processing structure 122 for performing various tasks.

The operating system 166 manages various hardware components of the computing device 102 or 104 via the logical I/O interface 168, manages the logical memory 180, and manages and supports the application programs 164. The operating system 166 is also in communication with other computing devices (not shown) via the network 108 to allow the application programs 164 to communicate with programs running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google Inc., Mountain View, CA, USA), or the like. The computing devices 102 and 104 of the computer network system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the application layer 162 for being processed by one or more application programs 164. Data generated by the application programs 164 may be sent to the logical I/O interface 168 for outputting to various output devices (via the output interface 132).

The logical memory 180 is a logical mapping of the physical memory 126 for facilitating the application programs 164 to access. In this embodiment, the logical memory 180 comprises a storage memory area 180S that may be mapped to a non-volatile physical memory such as hard disks, solid-state disks, flash drives, and/or the like, generally for long-term data storage therein. The logical memory 180 also comprises a working memory area 180W that is generally mapped to high-speed, and in some implementations, volatile physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the application layer 162 generally comprises one or more server-side application programs 164 which provide(s) server functions for managing network communication with computing devices 104 and facilitating collaboration between the server computer 102 and the computing devices 104. Herein, the term “server” may refer to a server computer 102 from a hardware point of view, or to a logical server from a software point of view, depending on the context.

As described above, the processing structure 122 is usually of no use without meaningful firmware and/or software. Similarly, while a computer system 100 may have the potential to perform various tasks, it cannot perform any tasks and is of no use without meaningful firmware and/or software. As will be described in more detail later, the computer system 100 described herein, as a combination of hardware and software, generally produces tangible results tied to the physical world, wherein the tangible results such as those described herein may lead to improvements to the computer and system themselves.

Users of the computer network system 100 may perform various actions or operations, and may access various data stored in the computer network system 100. Herein, the term “users” refers to any person who may access or try to access the computer network system 100 and operate therein. Therefore, users generally comprise authorized users and unauthorized users.

As those skilled in the art understand, the computer network system 100 generally has restrictions to the operations/actions and data access for its users. In other words, an operation or action may only be performed by an authorized user, and a piece of data may only be accessed by an authorized user. A user may be authorized to perform some operations/actions or access some data, and denied performing other operations/actions or accessing other data that are no authorized to this user. For example, an unauthorized user may be rejected to “enter” the computer network system 100 (for example, denied login).

An attack or incident (also called “cyber-attack or cyber-incident”, and collectively denoted a “network incident”, an “incident”, or a “threat” hereafter for ease of description) occurs when a threat actor performs malicious behaviour, such as when a user tries to perform an unauthorized operation/action or access an unauthorized piece of data. Such a network incident may be an external incident (for example, initiated by a user not authorized to access the computer network system 100 at all), or an internal incident (for example, an authorized user of the computer network system 100 trying to perform unauthorized actions or access unauthorized data).

For example, with reference to the computer network system 100 shown in FIG. 1, one or more of the server computers 102 and computing devices 104 may be associated with an organization. The computing devices 104 may comprise user devices that are used by employees of the organization, and/or computing devices 104 that are used by clients of the organization or other external entities and can interact with the organization by accessing certain information provided by a server computer and/or by communicating with devices used by employees. Network incidents may initiate from external sources (e.g. an external user device) or from internal sources (e.g. by an employee user device). It will be appreciated that cyber-security is of the utmost importance to organizations in order to protect confidential information, prevent breaches of customer/client data, etc.

FIG. 4 is a schematic diagram showing a simplified software structure 200 for detecting network incidents, according to some embodiments of this disclosure. As shown, the software structure 200 comprises an artificial intelligence (AI) engine 202 such as a machine learning (ML) engine having an AI model (such as a ML model) 204. The AI engine 202 receives network operations 206 (that is, user operations or actions) as input, analyzes the received network operations 206 using the AI model 204, and outputs the incident-detection results 208, which may include various detected incidents or threats including external cyber threats and insider threats. For example, the AI engine 202 may score the network operations 206 and detect network incidents based on the scores thereof.

A difficulty of the AI engine 202 in these embodiments is that building a single AI model for all types of network operations 206 may be difficult. For example, detecting potential data theft via a network action of uploading is fundamentally different from detecting malware activity.

Therefore, in some embodiments as shown in FIG. 5, the AI engine 202 pursues a divide and conquer methodology and classifies the input network actions 206 into a plurality of network operation streams 206-1, 206-2, 206-3 each comprising the network actions/operations (such as browsing, printing, emailing, or the like) that may cause incidents of a specific type or modality. In these embodiments, the AI engine 202 comprises a plurality of ML models 204-1, 204-2, and 204-3 (collectively identified using reference numeral 204) each for analyzing a respective network operation stream 206-1, 206-2, 206-3, and outputs the incidents 208-1, 208-2, 208-3 (also denoted “alerts” or “suspicious events”, and collectively identified using reference numeral 208) identified from the corresponding network operation stream 206-1, 206-2, 206-3.

Below are some examples of potential network incident types that may be detected by the AI engine 202 in some embodiments:
Suspicious robotic channel event: suspicious Robotic channels;
Screenshot exfiltration event: employees exfiltrating sensitive and confidential proprietary information through screenshot (that is, an event of taking a screenshot and then sending an outbound email);
Print: abnormal printing;
Abnormal data access event: abnormal access of clients' data (compared to people of similar job positions or titles));
Phishing link click event: clicking links on potential phishing campaigns.

Such a methodology simplified the development of ML models. Moreover, each ML-model output 208-1, 208-2, 208-3 comprises incidents of suspicious events that may be delivered to respective teams and/or stakeholders for processing. For example, the output from a ML model for printing incidents may be delivered to a team responsible for print, which is different from the team responsible for malwares.

Those skilled in the art will appreciate that AI models are usually not perfect, and they have different levels of noise. Consequently, the outputs 208-1, 208-2, 208-3 of the AI engine 202 may contain false incidents (that is, normal operations/actions that are incorrectly identified as incidents), and/or the AI engine 202 may fail to identify some suspicious operations/actions as incidents.

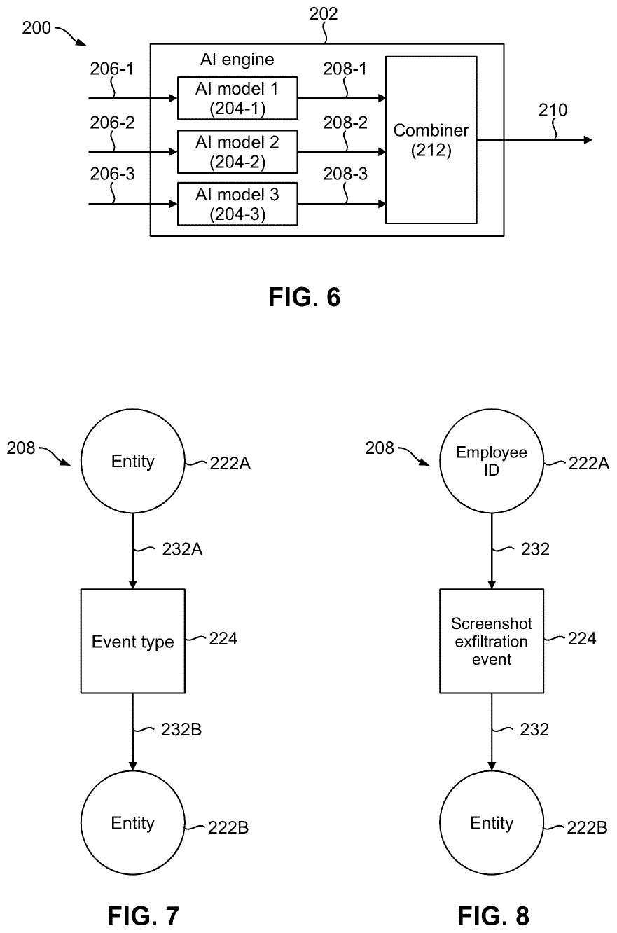

To improve the accuracy of incidents identification, and to provide a holistic view of a network incident that may have alerts detected by multiple different models across multiple modalities, in accordance with embodiments disclosed herein and as shown in FIG. 6, the ML-model outputs 208-1, 208-2, and 208-3 related to the same entity (e.g. a specific computing device, an employee ID, etc.) may be combined by a combiner module 212 using another AI model (which may be referred to as an “output AI model”) for a more comprehensive incident detection analysis and/or for delivering to a team responsible for these incidents. For ease of description, the ML-model outputs 208-1, 208-2, and 208-3 are denoted “ML-model outputs” or “alerts” or “suspicious events”, which may be true or false incidents, and the output 210 of the combiner module 212 is denoted “incidents” or “network incidents”, which represents identified incidents of a higher probability of being true incidents compared to the individual suspicious events 208-1, 208-2, and 208-3, and may comprise two or more suspicious events associated with an entity that have a low probability of having occurred randomly.

Combining the ML-model outputs 208-1, 208-2, and 208-3 may be advantageous because sometimes an incident does not unfold within a single modality but spreads to other modalities as well. For example, an employee taking advantage of their access rights can look up a lot of client information, take screenshots, and then attach them in an email to send to their personal address, or print them and take out of office, or even upload them to the Internet. As another example, an employee receiving a phishing email may click on a malicious attachment which in turn infects the employee's computer. Then, the infected computer may start a periodic check-up with its pre-defined command server set up by the attacker. Therefore, combining the alerts output from multiple ML models may provide a holistic view of the incidents.

In accordance with the present disclosure, methods, systems, apparatuses, and non-transitory computer-readable storage media are disclosed for detecting network incidents and providing a holistic view of network incidents using artificial intelligence, by analyzing the outputs 208-1, 208-2, 208-3, etc. from each of the ML models using the combiner module (212) and determining events associated with an entity that have a low probability or likelihood of having occurred randomly, and thus have a high probability of relating to a network incident. As described further herein, the outputs 208-1, 208-2, 208-3, etc. from each of the ML models may be analyzed by uniquely grouping them in such a way to find which set of entities are associated with malicious behaviours. The outputs may be grouped as subgraphs, which may be analyzed to determine interesting events using a time-based approach based on various statistical techniques.

Accordingly, an outcome is that sequences of suspicious events associated with an entity are evaluated rather than isolated events, allowing consumer teams to get a much broader context into the findings. Providing a holistic view of a network incident as a combination of suspicious events detected by different models also allows different stakeholders to come together to investigate cases that spilled over multiple environments or modalities. Analyzing plural of the various ML-model outputs 208-1, 208-2, and 208-3 may be advantageous because sometimes an incident does not unfold within a single modality but spreads to other modalities as well, as described above. Therefore, combining the alerts output from multiple ML models may provide a holistic view of the incidents and allow for better incident detection.

Technical advantages may also be realized by analyzing a graph view of the ML-model outputs 208-1, 208-2, and 208-3 instead of a standard table view. In particular, using a graph database provides immense speed improvements over a relational tabular approach. A graphical representation is helpful as it allows no constraint of schema, and thus a simpler dataset. Increased accuracy is achieved in how entities can be related together to create a concept of a meta entity. Lower false positives can be achieved through the definition/creation of “interesting pairs” that groups events together if they fulfill certain criteria. In some embodiments, the suspicious events may be analyzed using a time-based statistical approach. Using a time-based statistical approach to separate out certain event groupings helps to identify how risky a group of entities are. In other embodiments, the suspicious events may be analyzed using combinatorics to calculate a probability that suspicious events triggered by an entity occurred randomly.

As described above, in some embodiments such as is shown in FIG. 7, each ML-model output 208 may be represented as a graph comprising a plurality of nodes 222 and 224 connected by directional edges 232, wherein each directional edge connects two nodes and represents the relationship of the two connected nodes.

In these embodiments, two types of nodes are used for representing the ML-model output(s) as a graph, including entity node 222 and event type node 224. The entity node 222 may comprise an identifier (ID) of an entity (such as a machine or computing device 104, a user, an IP address of a machine or computing device 104), an email, a file, or the like. The event type node 224 comprises the type of the event 208 (such as the examples of the incident types described above). An entity node such as the entity node 222A in FIG. 7 may initiate an event type 224 (indicated by the arrow 232A), which may cause or otherwise lead to (indicated by the arrow 232B) one or more other entity nodes such as the entity node 222B. As will be shown in the examples below, an event type 224 may not cause or otherwise lead to any other entity nodes.

For example, as shown in FIG. 8, the entity 222A is an employee ID, which is associated with a screenshot exfiltration event 224A (viewing client information). The screenshot exfiltration event 224A is associated with an entity 222B of an external email sent by the employee ID 222A.

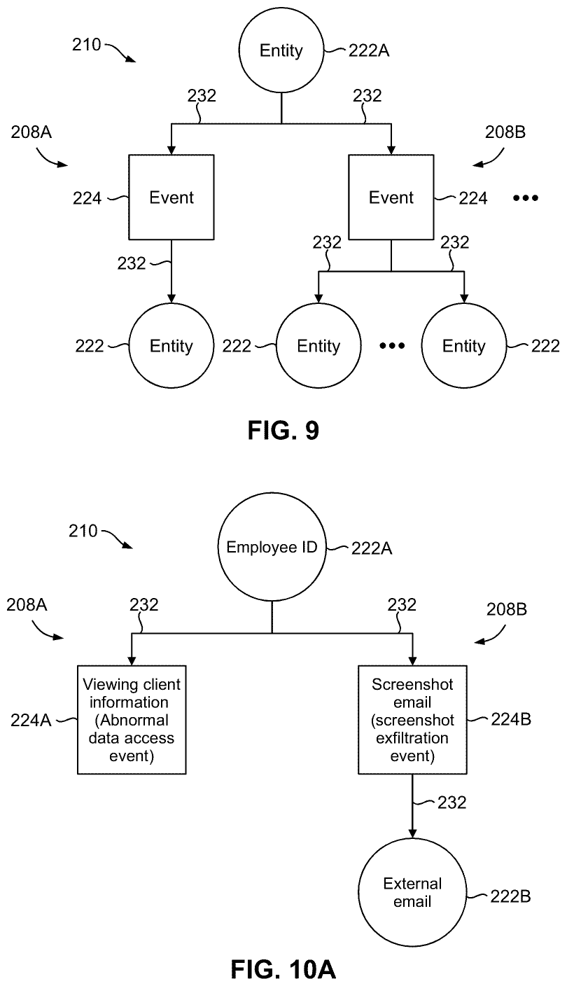

As shown in FIG. 9, a plurality of events 208, including from multiple different models, related to the same entity (such as entity 222A in FIG. 9) may be combined to form a combined event (i.e. as suspicious events associated with an entity) and represented as a combined graph 210.

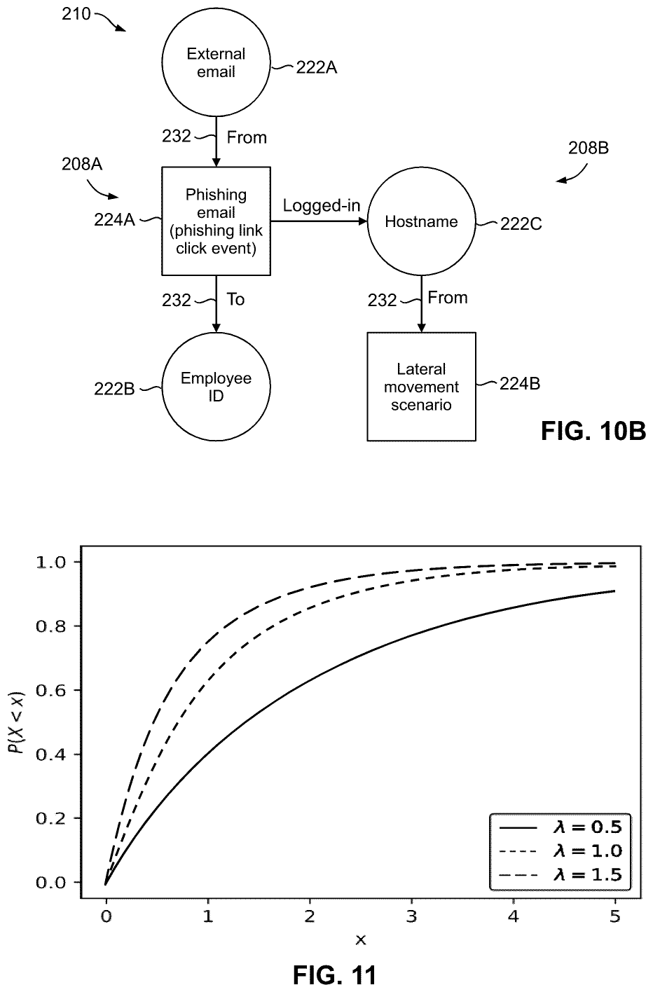

An example of a combined graph 210 is shown in FIG. 10A, wherein the two events 208A and 208B are related to the same entity 222A which is an employee ID. In the combined graph 210, the employee ID 222A is associated with an abnormal data access event 224A (viewing client information) and a screenshot exfiltration event 224B (sending an email with a screenshot). The abnormal data access event 224A is not associated with any other entity. The screenshot exfiltration event 224B is associated with an entity 222B of an external email sent by the employee ID 222.

Another example of a combined graph 210 is shown in FIG. 10B, wherein the two events 208A and 208B are related to the same entity 222A which is an external email. In the combined graph 210, the external email 222A is associated with a phishing link click event 224A (a phishing email), which is sent to an entity 222B (an employee ID), and causes a log-in to an entity 222C (a computer server represented by a hostname), which is in turn associated with an event 224B of a lateral movement scenario.

Thus, the events output from the AI models 204 may be combined into one or more combined events. For example, if the events output from the AI models 204 are all related by an entity, these events may be combined into a single combined event; otherwise, the events output from the AI models 204 may be combined into a plurality of combined events. After combining the events, the obtained one or more combined events form a single graph, wherein each combined event is a connected component (also denoted an “island”) of the graph.

The graph representation allows the AI engine 202 and more specifically the combiner module 212 to explore the relationship between a set of events related to the same entity to determine if the set of events form a causal attack/incident scenario. For example, a user looking up a lot of client data, taking some screenshots, and then sending them out in an email to their personal address would form a data theft scenario.

As those skilled in the art will appreciate, the order of the events may be important in determining an incident. For example, a look-up event (also called an “abnormal data access” event) followed by a screenshot exfiltration event of an anomalous outbound email would form a pair of interest. On the other hand, a look-up event may be irrelevant to an anomalous outbound email if the look-up event occurs after the anomalous outbound email. Therefore, in some embodiments, the AI engine 202 takes into account the order of the events in detecting the incidents, which may be done easily with a matrix wherein each row represents an event (wherein the elements of each row are, for example, the event name and a timestamp of the event occurrence), and the rows are ordered per the timestamps. For example, a matrix of events related to an EmployeeID may be:

$$[ \begin{matrix}“ AbnormalDataAccessEvent ” & 0 \\ “ ScreenshotExfiltrationEvent ” & 5\end{matrix} ] ,$$

wherein the rows (that is, the abnormal data access event and screenshot exfiltration event) are ordered based on their timestamps 0 and 5, meaning that the abnormal data access event occurred first and the screenshot exfiltration event occurred thereafter.

In some embodiments, a dictionary (denoted “interesting-events dictionary”) is used for denoting the interesting pairs (that is, ordered event pairs that may potentially be a network incident), which may also be represented as a matrix (denoted “interesting-events matrix”), wherein, in each row, the first column denotes the first event, and the second column denotes the second event occurred after the first event, for example,

$$[ \begin{matrix}“ AbnormalDataAccessEvent ” & “ ScreenshotExfiltrationEvent ” \\ “ AbnormalDataAccessEvent ” & “ PrintEvent ”\end{matrix} ] .$$

Those skilled in the art will appreciate that, in other embodiments, a dictionary or matrix denoting interesting ordered list of events (that is, each row of the matrix comprising an ordered list of two or more events), the combination thereof may potentially be a network incident.

As those skilled in the art will appreciate, there may be false events with coincidental co-occurrences which, if combined, may be interpreted as an incident. In such situations, the timing of these operations/actions may be important in correctly determining the incident. Generally, events that happen closer together in time are more likely to be casually related, compared to events that happen further apart in time. Thus, if an entity triggered a pair of events that is a match (that is, the pair of events match a record of the interesting-events dictionary or a row of the interesting-events matrix), then the timing of these events is generally relevant to the determination of an incident.

Therefore, in some embodiments, the time between two consecutive events may be used to quantify the confidence on these events being casually connected rather than an artifact of coincidence. More specifically, in this embodiment the AI engine 202 considers that the time between two event types (denoted “time-delta”) follows an exponential distribution, that is, having a probability density function as:

$$f ( x ; λ ) = \{ \begin{matrix}1 - {e}^{- λ x ,} & x \geq 0 \\ 0 , & x < 0\end{matrix} \qquad ( 1 )$$

where λ is the rate parameter and x is the time-delta, which is a random variable. Then, for each pair of event types that is a match, the AI engine 202 computes a probability that the pair of events occurred randomly based on the time therebetween. Exponential distribution is useful since it has minimum level of prior assumptions and hence represents the state of knowledge well. FIG. 11 shows the cumulative distribution function (CDF) of f(x; λ) with different values of 2.

In these embodiments, the rate parameter λ is obtained empirically by collecting time-deltas for all pairs of event types and computing the rate parameter/using maximum likelihood estimate, which means taking the inverse of their average as the rate parameter λ, that is, λ=1/(average time-delta).

In some embodiments, the AI engine 202 may find in its datasets (such as its training datasets, or a dataset of known network incidents) all cases having the same types of events and in the same order wherein the events in each case are related to a same entity (however, the events in different cases may not be related to the same entity), calculate the time-delta of each case, and then calculate the mean of these time-deltas. The rate parameter/is obtained as the inverse of the mean of these time-deltas.

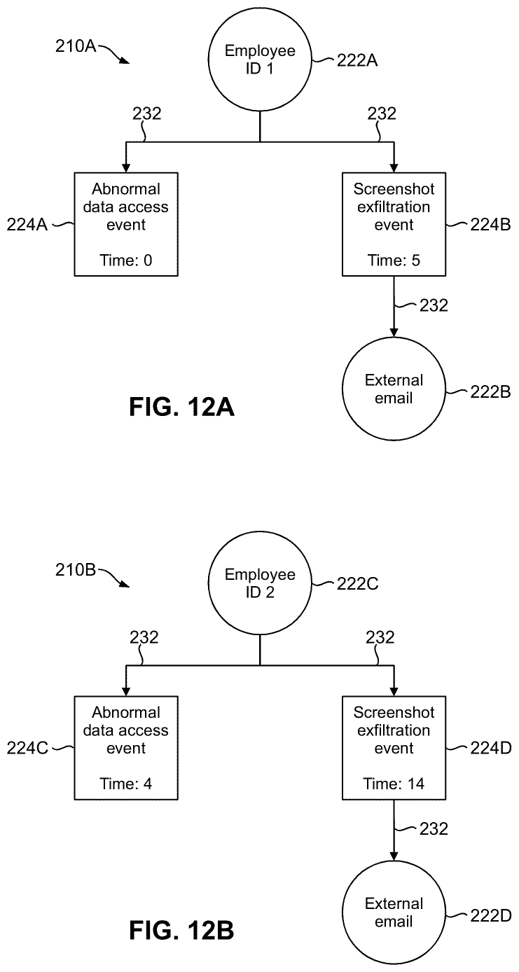

For example, as shown in FIGS. 12A and 12B, the AI engine 202 finds two cases 210A and 210B (each is a combined event and represented as a combined graph). The case 210A comprises an entity node 222A of employee ID 1 initiated an abnormal data access event 224A at time zero (0) followed by a screenshot exfiltration event 224B at time five (5). The screenshot exfiltration event 224B causes an external email 222B. The case 210B comprises an entity node 222C of employee ID 2 initiated an abnormal data access event 224C at time four (4) followed by a screenshot exfiltration event 224D at time 14. The screenshot exfiltration event 224D causes an external email 222D.

In case 210A, the time-delta between the abnormal data access event 224A and the screenshot exfiltration event 224B is five (5). In case 210B, the time-delta between the abnormal data access event 224C and the screenshot exfiltration event 224D is 10. The mean time-delta is the average of the two time-deltas, and equals to 7.5. Then, the rate parameter λ is 1/7.5.

In some embodiments, the combiner module 212 combines the events 208 output from the AI models 204 in accordance with the entities related thereto, wherein in each combined event, the event types are ordered in accordance with their times of occurrence. Then, the combiner module 212 identifies in each combined event all ordered pairs of event types that match the interesting-events dictionary/matrix.

For each identified pairs of event types, the combiner module 212 calculates a probability value representative of a probability that the pair of events occurred randomly based on the time-delta and the rate parameter 1. The probability values may be converted to surprise scores via logarithmic transformation, i.e. to represent how surprising it is that the two events occurred in this sequence at the time-delta. Then, all scores are summed up for the combined event and the final score is propagated to all the event types in the combined event.

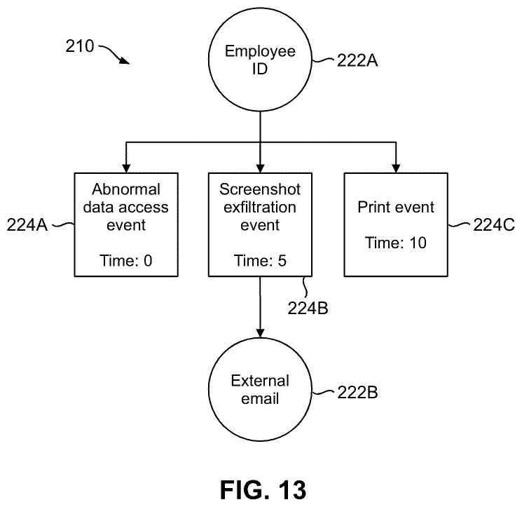

FIG. 13 shows an example, wherein an employee 222A triggered a client-lookup (a abnormal data access event 224A) at time zero (0), an anomalous outbound email (a screenshot exfiltration event 224B) at time five (5), and an anomalous print (Print event 224C) at time 10. The ordered pairs of event types for the employee ID 222A include: (a) client look-up (abnormal data access event 224A) then sending outbound email (screenshot exfiltration event 224B), and (b) client look-up (abnormal data access event 224A) then print (Print event 224C). As those skilled in the art will appreciate, there are two potential scenarios in this example: (i) the employee ID 222A looked up data then emailed it out, or (ii) the employee ID 222A looked up data and then printed it. The combiner module 212 essentially computes the probability of each pair of event types occurring randomly (that is, the probability of the abnormal data access/screenshot exfiltration event pair 224A-224B, and the probability of the abnormal data access/print event pair 224A-224C), converts the calculated probabilities to their logarithms to calculate a surprise score, and then calculates the summation of these logarithms (wherein the summation is denoted a “surprise” hereinafter) to calculate a total surprise of the actions by the entity 222A. More specifically, the combiner module 212 computes the probabilities for time delta of five (5) between the client look-up 224A and email 224B, and for time delta of 10 between the client look-up 224A and print 224C. The external email entity 222B is ignored since there is no ordered pair of event types for it.

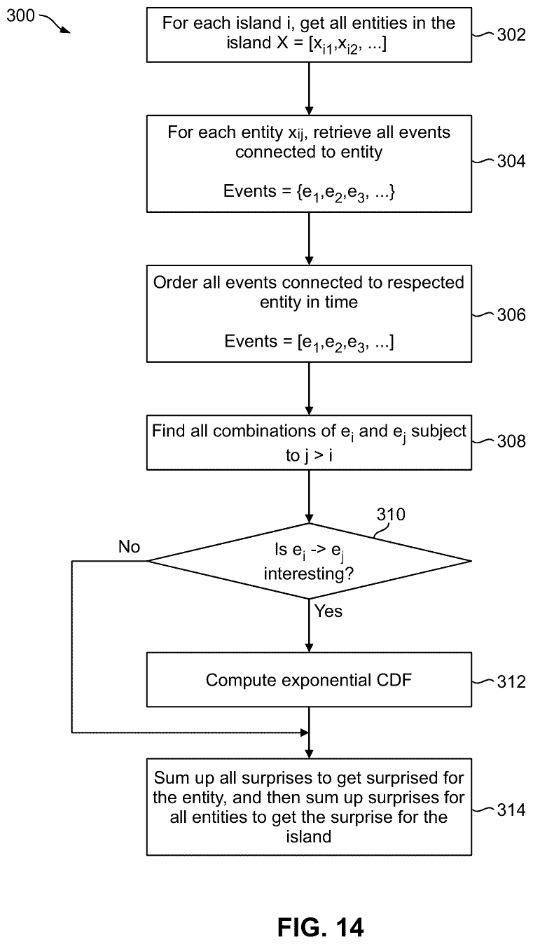

FIG. 14 is a flowchart showing a method or procedure 300 for calculating the probabilities of a combined event or an island.

At step 302, for each island i, the combiner module 212 obtains all entities 222 therein as: X=[xᵢ₁, xᵢ₂, . . . ], where X represents the set of entities xᵢ₁, xᵢ₂, . . . .

At step 304, for each entity xᵢⱼ, the combiner module 212 retrieves all event types connected thereto into a set as: Events={e₁, e₂, e₃, . . . }, where e₁, e₂, e₃, . . . are the retrieved event types, and “{ }” represent an unordered set.

At step 306, the combiner module 212 orders all events e₁, e₂, e₃, . . . connected to the entity xᵢⱼ in accordance with their occurrence times as: Events={e₁, e₂, e₃, . . . }, where “[ ]” represent an ordered set.

At step 308, the combiner module 212 identifies all combinations of ordered event pairs, that is, all combinations of eᵢ and eⱼ subject to j>i.

At step 310, the combiner module 212 checks if each identified event pair (represented as eᵢ->eⱼ) is an interesting event pair (that is, an event pair matching the interesting pairs dictionary).

If an event pair eᵢ->eⱼ is not an interesting pair (the “No” branch from step 310), this event pair is ignored. If an event pair eᵢ->eⱼ is an interesting pair (the “Yes” branch from step 310), the combiner module 212 calculates the CDF of the exponential distribution (step 312).

After all event pairs are checked, and the CDF of the exponential distribution of the interesting pairs are calculated, the combiner module 212 sums up all surprises (each of which is converted from the corresponding probability value via logarithmic transformation.) to obtain the surprise (that is, the summed CDFs) for the entity, and then sum up surprises for all entities to get the surprise for the island (step 314). The procedure 300 then ends.

Below is the mathematical formulation of how final scores are computed, according to some embodiments of this disclosure.

The surprise of island J is:

$$P ( J ) = - 1 * {\sum }_{i = 0}^{n} P ( {x}_{i , j} ) , for {x}_{i , j} ∈ J \qquad ( 2 )$$

where P (x_{i,j}) refers to surprise of entity i belonging to island j.

The surprise of entity x_{i,j} is:

$$P ( {x}_{i , j} ) = {\sum }_{i = 0}^{n} {\sum }_{j = i + 1}^{n} Θ ( Δ ( time ( {e}_{j} ) , time ( {e}_{i} ) ) ; {λ}_{label ( {x}_{i , j} ) , label ( {e}_{i} ) - labe l ( {e}_{j} )} ; label ( {e}_{i} ) - label ( {e}_{j} ) ) where \qquad ( 3 )$$

$$Θ ( x ; λ , combination ) = \{ \begin{matrix}log ( 1 - {e}^{- λ x} ) , & if combination ∈ Interesting Events \\ 0 , & otherwise\end{matrix} \qquad ( 4 )$$

Events connected to entity are first ordered in time subject to time (e₁)<time (e₂)< . . . <time (eₙ) so that time (eⱼ)-time (eᵢ)≥0 if j>i. The piecewise function (4) contains the exponential CDF that accepts a rate parameter λ and time-delta x≥0.

After calculating the surprise of island J, the calculated surprise (that is, the score) of island J is compared to a predefined score threshold. If the score of island J is greater than the score threshold, the island or combined event J is determined as an incident, which is then output from the combiner module 212.

Thus, in above embodiments, the combiner module 212 combines the outputs of the AI models 204 into a single graph data structure thereby allowing natural correlation of events for facilitating the identification of the type of alerts an entity (such as hostname, external email, employee ID, computer name, IP, or the like) has triggered and for facilitating the determination regarding whether these alerts coming from different modalities constitute a legitimate attack or incident scenario. Thus, the AI engine 202 in these embodiments provides output for detecting sequences of events rather than isolated events which allows cyber-security teams to obtain a much broader context into the findings. It also allows different stakeholders to come together to investigate cases that spilled over multiple environments or modalities.

By using the combiner module 212, the events are grouped to find which set of entities are creating malicious behaviors. This is done through looking at subgraphs and computing a time-based approach using various statistical techniques. More specifically, the AI engine 202 disclosed herein has the following important features:
analyzing outputs of various AI models through an entity resolution approach;
the AI-model outputs are analyzed from a graph view instead of a standard table view;
determining a collaborated set of interesting events between meta entities (wherein a meta entity comprises one or more entities that may relate other entities together; for example, an Employee ID may be logged into a hostname, and therefore, any events that the hostname has done may be considered also being done by the employee ID; in this example, the meta entity is the combination of the hostname and Employee ID); and
calculating the scores of events using a time-based statistical approach.

By using the AI engine 202 disclosed herein, lower false positives are achieved through the creation of an “interesting pair” concept that groups events together if they fulfill certain criteria, and through the use of statistical time-based approach to separate certain event grouping to identify how risky a group of entities may be.

As a comparison, a prior-art method is to use a Bayesian approach without a pre-defined set of interesting events to identify how anomalous entities were. This method may lead to many false positives (that is, false incident detections) because of the existence of confusing events that are anomalous but not risky. Compared to the method disclosed herein, the lack of time-based approach in the prior-art method may lead to more false positives since, in the prior-art method, two events that are very far away from each other in time may be considered interesting, although such events are not related to each other.

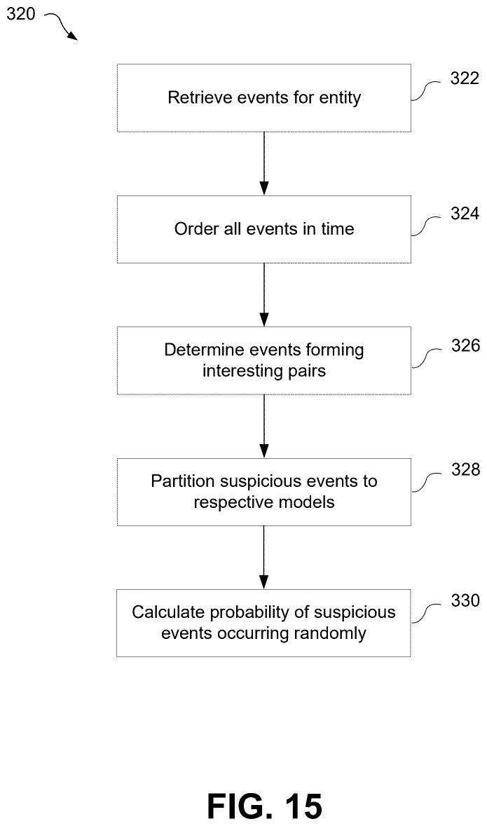

While a time-based statistical approach is described above for calculating probabilities that two or more suspicious events occurred randomly, it will be appreciated that alternative methods may be used to calculate the probabilities. FIG. 15 is a flowchart showing a method or procedure for calculating the probabilities of a combined event, according to further embodiments of this disclosure. The method 320 shown in FIG. 15 may be performed by the combiner module 212 shown in FIG. 6.

The method 320 similarly comprises retrieving all event types connected to an entity (322) into a set as: Events={e₁, e₂, e₃, . . . }, where e₁, e₂, e₃, . . . are the retrieved event types, and “{ }” represent an unordered set.

At step 324, the combiner module 212 orders all events e₁, e₂, e₃, . . . connected to the entity in accordance with their occurrence times as: Events={e₁, e₂, e₃, . . . }, where “[ ]” represent an ordered set.

At step 326, the combiner module 212 determines suspicious events that form ordered pairs of interesting events, i.e. by identifying all combinations of ordered event pairs, that is, all combinations of e; and eⱼ subject to j>i. and checking if each identified event pair (represented as eᵢ->eⱼ) is an interesting event pair (that is, an event pair matching the interesting pairs dictionary).

At step 328, the combiner module 212 partitions the suspicious events associated with the entity that form ordered pairs to their respective models. Each respective model across all entities in the database has Mᵢ alerts and the entity at hand has mᵢ alerts for each respective model.

At step 330, the combiner module 212 calculates the probability that suspicious events associated with the entity occurred randomly by using an approach that analyzes how many events an entity has triggered by the AI models compared to the total number of suspicious events detected by the AI models. More specifically, in this approach, the probability of a sequence of suspicious events associated with an entity occurring randomly is calculated by:
Calculating that the entity at hand has total n alerts where n=Σmᵢ and calculating there are in total N alerts in the database where N=ΣMᵢ. (Here, mᵢ is zero for models that the entity did not have any alert from).
Calculating that there are

$$( \begin{matrix}N \\ n\end{matrix} )$$

combinations or n alerts that could be observed for the entity at hand across all models. This forms the denominator of the probability calculation.
Calculating that there are

$$( \begin{matrix}{M}_{\dot{t}} \\ {m}_{\dot{t}}\end{matrix} )$$

ways of choosing mᵢ alerts from Mᵢ alerts for each model. The product

$$\prod ( \begin{matrix}{M}_{i} \\ {m}_{i}\end{matrix} )$$

for the respective models forms the numerator of the probability calculation.
Calculating the probability that the suspicious events associated with the entity occurred randomly (i.e. are independent) by dividing the numerator by the denominator, as shown in the following equation:

$$\frac{\prod ( \begin{matrix}{M}_{i} \\ {m}_{i}\end{matrix} )}{( \begin{matrix}N \\ n\end{matrix} )}$$

Since the probability calculation assumes independence, getting a low probability increases the likelihood of a potential dependence across the alerts. A surprise score can also be calculated from the calculated probability (e.g. by logarithmic transformation), which can be compared against an alert threshold and used to trigger an alert when the surprise score exceeds the threshold.

An example of the methodology shown in FIG. 15 is now described. Consider a findings database containing N alerts/suspicious events output from a plurality of AI models with timestamps on them. An entity has triggered n alerts. The interesting pair database indicates that suspicious events in the format Model A→Model B, and Model C→Model D, that is a suspicious event detected by Model A followed by a suspicious event detected by Model B, and a suspicious event detected by Model C followed by a suspicious event detected by Model D, are interesting pairs of suspicious events. In this example, the n alerts associated with the entity comprise suspicious events detected by the models in the following order: <[Model C, Model A, Model B, Model D, Model C, Model B]>.

To calculate the probability that these events occurred randomly, the ordered list of suspicious events is filtered to determine pairs of suspicious events that match suspicious event pairs in the dictionary. The first suspicious event detected my ‘Model C’ is retained because later in the sequence is a suspicious event detected by ‘Model D’. The second suspicious event detected by ‘Model A’ is retained as well since later there is a suspicious event detected by ‘Model B’. The third suspicious event detected by ‘Model B’ and the fourth suspicious event detected by ‘Model D’ are retained as they were mentioned in the context of first two suspicious events, but the fifth suspicious event detected by ‘Model C’ is not needed and is filtered out, because no event prior to it forms an interesting pair with it and no event coming after does so either. The sixth suspicious event detected by ‘Model B’ is retained since there is a suspicious event detected by ‘Model A’ in the beginning. Accordingly, the probability is calculated based on the suspicious events that match suspicious event pairs in the dictionary, i.e. the following list of ordered suspicious events: <[Model C, Model A, Model B, Model D, Model B]>.

As described above, the AI engine 202 outputs an alert based on the calculated probability, such as when combined events have surprises or scores thereof greater than the score threshold (which are classified as network incidents), so as to trigger an alert.

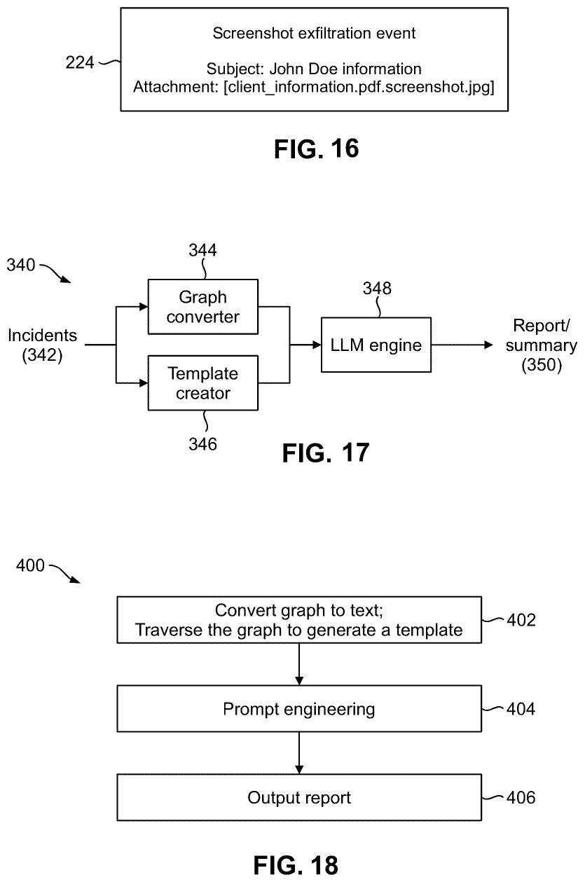

Those skilled in the art will appreciate that, in addition to the probabilities and/or scores calculated for each combined event, the nodes of the combined events also comprise rich information. For example, as shown in FIG. 16, a screenshot exfiltration event may comprise various information such as “Subject: John Doe information” (indicating an entity that the event is related to) and “Attachment: [client_information.pdf.screenshot.jpg]” (indicating what was sent out).

Therefore, it may be preferable to compile the information of the nodes in a human-readable manner to provide alerts with more details regarding the incidents, which will help users to fully understand the nature of the incidents, such as
what are the subject and attachments in the email?
is there anything suspicious in the attachment name relating to financial or client information?
is there any names present in the events?

For such a purpose, in some embodiments, the network incidents 210 identified by the AI engine 202 may be further processed by a large language model (LLM) engine using a suitable LLM such as Llama 2 (which is an open-source large language model offered by Meta Platforms, Inc. of Menlo Park, California, USA), ChatGPT offered by OpenAI of San Francisco, California, USA, Mixtral offered by Mistral AI of Paris, France, or the like, to provide meaningful and information-rich reports with, for example, overarching narratives on the incidents. Such reports are useful to help users such as investigators to focus on specific nodes within the incidents. The use of LLMs may also be helpful when the incidents comprise many different modalities and some modalities may occur with large frequency.

However, a problem arises with LLMs since they usually accept text input and cannot accept graph objects as input. Moreover, the prompt is preferably not to be the same for each island since different modalities may require different questions that may be associated therewith.

FIG. 17 is a schematic diagram showing an information-processing module 340 for processing the incidents 342 output from the AI engine 202, using a graph converter 344, a template creator 346 and a LLM engine 348, to generate an incident-detection report 350 optionally with a summary for highlighting suspicious activities, providing concise summary of each incident, and expediting the incident-investigation process. In various embodiments, the incidents 342 may be the incidents 208 output from the AI engine 202 shown in FIG. 4, or the incidents 208-1 to 208-3 output from the AI engine 202 shown in FIG. 5, or the incidents 210 output from the AI engine 202 shown in FIG. 6.

FIG. 18 is a flowchart showing a procedure 400 performed by the information-processing module 340 for generating the incident-detection report 350 using the LLM, which will be described with reference to FIG. 17.

As shown in FIG. 17, the incidents 342 output from the AI engine 202 collectively form an incident graph, which is input to the graph converter 344 and the template creator 346.

At step 402, the graph converter 344 transverses the incident graph 342 to convert the incident graph (that is, the incidents) to a text format (denoted a “text-format graph”) and sends the converted text to the LLM engine 348. When converting the incident graph to text, the graph converter 344 extracts the numerical features from the incident graph, and converts the numerical features into descriptive text.

At this step, the template creator 346 also transverses the incident graph 342 and extract the information of the nodes of the incident graph 342 to create a template. More specifically, the template creator 346 focuses on different attributes of the nodes of the incident graph 342 and collects information regarding what modalities are present within the incident graph 342, to create a specific prompt for the LLM engine 348 based on each modality. For example, attachment and subject lines are relevant only if there is a screenshot exfiltration event present. Thus, by creating a template, the information-processing module 340 customizes the prompts for inputting to the LLM engine 348. When there are multiple nodes (e.g. entities) associated with an incident, a single template may be provided to reduce duplication and thus the number of reports generated.

At step 404, the LLM engine 348 receives the text-format graph from the graph converter 344 and the template from the template creator 346, and processes the text-format graph based on the template (which is also called a process of “prompt engineering”) to generate an incident-detection report. The report may be or may comprise a summary for enhanced highlighting and succinctly describing the graph and specific attributes the investigator may focus on.

At this step, the user may also provide customized prompts based on event types. Moreover, for efficient execution, this step may be performed on graphic processing units (GPUs).

At step 406, the LLM engine 342 outputs the generated incident-detection report.

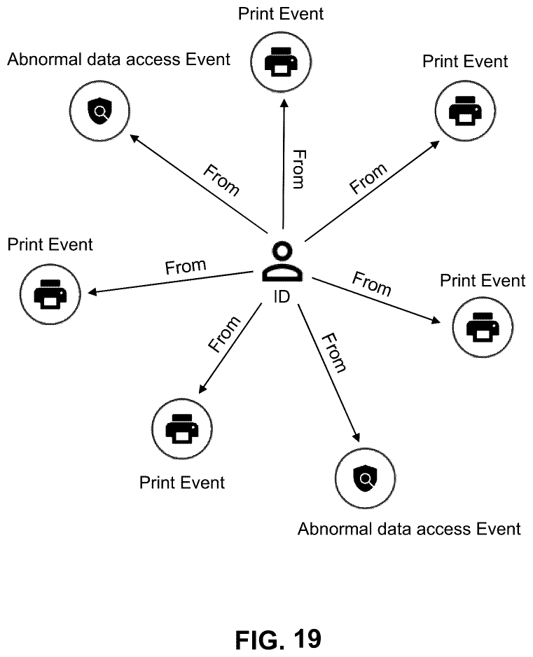

For example, the AI engine 202 may output a detected incident as an incident graph. For ease of presentation, the incident graph may be described as follows (also see FIG. 19):

“An employee with the name of Elon James based in Canada with the job title Mortgage Specialist accessed client data via Sales Platform. The number of client inquiries made by this operator on the alerted day is 58. After 21 days, an employee printed a document with the name of 2021 2022 t4 and tfsa statements.pdf and is 19 pages. After 3 days, an employee accessed client data via Sales Platform. The number of client inquiries made by this operator on the alerted day is 126. On the same day, an employee printed the document with the name of viewcarreport.ashx and is 29 pages. After one day, an employee printed a document with the name of lease_58 kidd_mainfloor_signed.pdf and is 14 pages. On the same day, an employee printed the document with the name of lease agreement_58 kidd_basement_signed_april132023.pdf and is 14 pages. After 1 day, an employee printed a document with the name of annie 2022 t1 general.pdf and is 13 pages.”

The incident graph is sent to the information-processing module 340. The graph converter 344 converts the incident graph to a text format, and the template creator 346 transverses the incident graph and creates the following template for the LLM engine 348 (step 402):

“Generate a short summary of the following text about an employee behavior in a few sentences in English. Highlight if there is anything suspicious but if not write what the files or attachments are about. Also, list any person names in the text and highlight if they are the same or different from the name of the employee.”

At step 404, the LLM engine 348 uses the LLM to process the text-format incident based on the template, and generate a report as follows:

“Based on the text, there are several suspicious activities detected in the system related to an employee named Elon James. On three separate occasions, the employee accessed client data via the Sales Platform, with a high volume of inquiries on the third occasion. Additionally, the employee printed several documents with sensitive information, including financial statements and lease agreements, on different dates. The names of the documents and the number of pages suggest that the employee may have been attempting to gather and print confidential information. However, without further context or investigation, it is not possible to determine the exact nature of the employee's actions or their intentions.

### Person Names Mentioned in the Text:

Elon James (employee)
Annie (not specified if this is a person or a document)

### Highlighted Suspicious Activities:

High volume of client inquiries on the third occasion
Printing of sensitive documents, including financial statements and lease agreements, on different dates.”

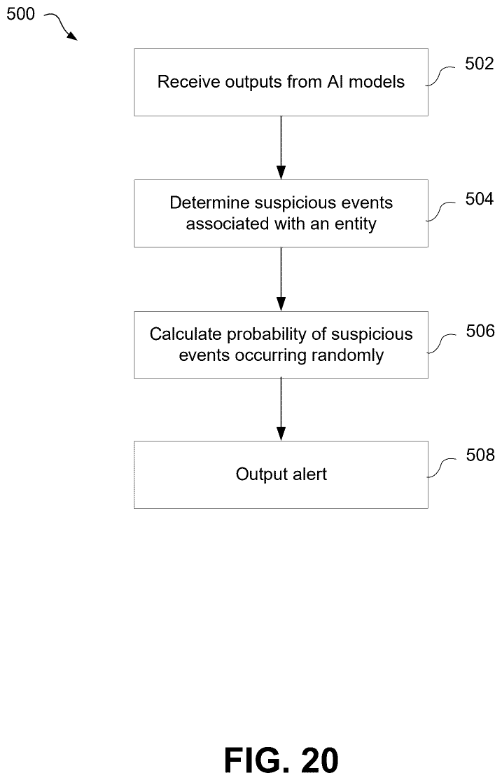

Herein, various embodiments of network incident detection methods are described. FIG. 20 shows a general method 500 for detecting network incidents in accordance with embodiments of this disclosure.

The method 500 comprises receiving outputs from a plurality of artificial intelligence (AI) models analyzing a plurality of network operation streams (502). The plurality of AI models are respectively trained to detect suspicious events corresponding to a potential type of network incident in a respective network operation stream and to output an alert when a suspicious event is detected.

From the outputs of the plurality of AI models, the method 500 comprises determining a plurality of suspicious events that are associated with an entity (504). A probability that two or more of the plurality of suspicious events associated with the entity occurred randomly is calculated (506), and an alert is output based on the probability (508). In particular, a low probability indicates a potential link between events, i.e. that the events are nonrandom. Accordingly, the alert may be output when the probability is low (e.g. lower than a threshold value), indicating a potential link between the suspicious events. Additionally or alternatively, a surprise score may be calculated based on the probability, and the alert may be output when the surprise score exceeds a threshold value

In some embodiments, the method 500 further comprises creating an ordered list of suspicious events by ordering the plurality of suspicious events associated with the entity based on a time of respective suspicious events, and filtering the ordered list of suspicious events by: accessing a dictionary of suspicious event pairs; and filtering the ordered list of suspicious events to determine pairs of suspicious events that match suspicious event pairs in the dictionary. The probability may be calculated based on the suspicious events that match suspicious event pairs in the dictionary.

In some embodiments, the probability is calculated by: partitioning the suspicious events that match suspicious event pairs in the dictionary to respective AI models; determining, for each of the respective AI models, a number of suspicious events associated with the entity; calculating a sum of all suspicious events associated with the entity by adding the number of suspicious events associated with the entity across the respective AI models; determining, for each of the respective AI models, a number of suspicious events associated with all entities; calculating a sum of all suspicious events associated with all entities by adding the number of suspicious events associated with all entities across the respective AI models; and calculating the probability that the suspicious events occurred randomly using the following Equation:

$$\frac{\prod ( \begin{matrix}{M}_{i} \\ {m}_{i}\end{matrix} )}{( \begin{matrix}N \\ n\end{matrix} )}$$

where Mᵢ is the number of suspicious events associated with all entities for a respective AI model i, mᵢ is the number of suspicious events associated with the entity for the respective AI model i, N is the sum of all suspicious events associated with all entities across the respective AI models, and n is the sum of all suspicious events associated with the entity across the respective AI models.

In some embodiments, calculating the probability may be based on a time of occurrence between a pair of suspicious events. A mean time-delta of known network incidents having two event types corresponding to the pair of suspicious events may be calculated by accessing a database storing suspicious events and timing information for known incidents, and the probability may be calculated based on the time of occurrence between the two suspicious events and the mean time-delta, for example by using an exponential cumulative distribution function.

The method may further comprise calculating a surprise score based on the probability that the two or more of the plurality of suspicious events occurred randomly, and outputting the alert when the surprise score exceeds a threshold value.

The plurality of suspicious events associated with the entity may be represented as an ordered graph, and the method may further comprise: converting the ordered graph to a textual format; generating a template based on nodes present in the ordered graph; customizing a prompt for inputting to a large language model (LLM) to summarize the ordered graph, wherein the prompt is customized based on the template; and prompting the LLM to generate a summary report of the two or more suspicious events using the textual format of the ordered graph.

In some embodiments, the methods disclosed herein may be implemented as one or more circuits of a module, a device, an apparatus, a system, and/or the like. In some embodiments, the methods disclosed herein may be implemented as computer-executable instructions stored in one or more non-transitory computer-readable storage devices such that, the instructions, when executed, may cause one or more circuits to perform the methods disclosed herein. A system may comprise an artificial intelligence (AI) engine comprising a plurality of AI models respectively trained to determine suspicious events corresponding to a potential type of network incident in a respective network operation stream; one or more processors; and one or more non-transitory computer-readable storage media comprising computer-executable instructions, wherein the computer-executable instructions, when executed, cause one or more circuits to perform the method. The system may further comprise a database storing a dictionary of suspicious event pairs; a database storing suspicious events and timing information of known network incidents; and/or an information-processing module for generating a summary report from an ordered graph.

It will be appreciated that the embodiments disclosed herein provide various technical features and benefits. Technical features and benefits of above-described embodiments may include:
increased collaboration among different governing bodies within an organization;
increased collaboration of data scientists and cyber analysts;
increased confidence through evidence on malicious behaviors;
prevention of malicious behaviors through resilience;
detection of new and unknown malicious behaviors and attack patterns;
increased customer confidence through prevention of data theft; and.
drive a holistic dialogue on threat actors.

The network incident detection methods disclosed herein provide incident detection with improved accuracy and a holistic view. The outputs of the network incident detection methods disclosed herein enables improved understanding of threat actors and how they operate, and may reconcile an array of data sources each containing an immense amount of data and synthesizing them to a clear understanding.

Those skilled in the art will appreciate that such various embodiments and/or features thereof may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method for detecting network incidents, the method comprising:
receiving outputs from a plurality of artificial intelligence (AI) models analyzing a plurality of network operation streams, wherein the plurality of AI models are respectively trained to detect suspicious events corresponding to a potential type of network incident in a respective network operation stream and to output an alert when a suspicious event is detected;
determining, from the outputs of the plurality of AI models, a plurality of suspicious events that are associated with an entity;
calculating a probability that two or more of the plurality of suspicious events associated with the entity occurred randomly; and
outputting an alert based on the probability.

2. The method of claim 1, further comprising creating an ordered list of suspicious events for use in calculating the probability by ordering the plurality of suspicious events associated with the entity based on a time of respective suspicious events.

3. The method of claim 2, further comprising filtering the ordered list of suspicious events by:
accessing a dictionary of suspicious event pairs; and
filtering the ordered list of suspicious events to determine pairs of suspicious events that match suspicious event pairs in the dictionary,
wherein the probability is calculated based on the suspicious events that match suspicious event pairs in the dictionary.

4. The method of claim 3, wherein the probability is calculated by:
partitioning the suspicious events that match suspicious event pairs in the dictionary to respective AI models of the plurality of AI models;
determining, for each of the respective AI models, a number of suspicious events associated with the entity;
calculating a sum of all suspicious events associated with the entity by adding the number of suspicious events associated with the entity across the respective AI models;
determining, for each of the respective AI models, a number of suspicious events associated with all entities;
calculating a sum of all suspicious events associated with all entities by adding the number of suspicious events associated with all entities across the respective AI models; and
calculating the probability that the suspicious events occurred randomly using the following Equation:
$$\frac{\prod ( \begin{matrix}{M}_{i} \\ {m}_{i}\end{matrix} )}{( \begin{matrix}N \\ n\end{matrix} )}$$
where Mᵢ is the number of suspicious events associated with all entities for a respective AI model i, mᵢ is the number of suspicious events associated with the entity for the respective AI model i, N is the sum of all suspicious events associated with all entities across the respective AI models, and n is the sum of all suspicious events associated with the entity across the respective AI models.

5. The method of claim 3, wherein calculating the probability is based on a time of occurrence between a pair of suspicious events.

6. The method of claim 5, wherein a mean time-delta of known network incidents having two event types corresponding to the pair of suspicious events is calculated by accessing a database storing suspicious events and timing information for known incidents, and wherein the probability is calculated based on the time of occurrence between the two suspicious events and the mean time-delta.

7. The method of claim 6, wherein the probability is calculated using an exponential cumulative distribution function.

8. The method of claim 1, further comprising calculating a surprise score based on the probability that the two or more of the plurality of suspicious events occurred randomly, and outputting the alert when the surprise score exceeds a threshold value.

9. The method of claim 1, wherein the alert is output when the probability is lower than a threshold value.

10. The method of claim 1, wherein the plurality of suspicious events associated with the entity is represented as an ordered graph.

11. The method of claim 10, further comprising:
converting the ordered graph to a textual format;
generating a template based on nodes present in the ordered graph;
customizing a prompt for inputting to a large language model (LLM) to summarize the ordered graph, wherein the prompt is customized based on the template; and
prompting the LLM to generate a summary report of the two or more suspicious events using the textual format of the ordered graph.

12. One or more non-transitory computer-readable storage media comprising computer-executable instructions, wherein the computer-executable instructions, when executed, cause one or more circuits to perform the method of claim 1.

13. A system, comprising:
an artificial intelligence (AI) engine comprising a plurality of AI models respectively trained to determine suspicious events corresponding to a potential type of network incident in a respective network operation stream;
one or more processors; and
one or more non-transitory computer-readable storage media comprising computer-executable instructions, wherein the computer-executable instructions, when executed, cause one or more circuits to perform the method of claim 1.

14. The system of claim 13, further comprising a database storing a dictionary of suspicious event pairs.

15. The system of claim 13, further comprising a database storing suspicious events and timing information of known network incidents.

16. The system of claim 13, further comprising an information-processing module for generating a summary report from an ordered graph.
